(19) United States
(12) Patent Application Publication
(10) Pub. No.: US 2009/0065975 A1
(43) Pub. Date: Mar. 12, 2009

(54) MANUFACTURING PROCESS FOR HIGH PERFORMANCE LIGNOCELLULOSIC FIBRE COMPOSITE MATERIALS

(76) Inventors: Mohini M. Sain, Toronto (CA); Suhara Panthapulakkal, Toronto (CA); Shiang F. Law, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/093,868

(22) PCT Filed: Sep. 11, 2006
(86) PCT No.: PCT/CA2006/001482

§ 371 Date: Nov. 13, 2008

(30) Foreign Application Priority Data
Nov. 18, 2005 (CA) 2527325

(51) Int. Cl. B29C 43/00

(52) U.S. Cl. 264/258; 366/97

(57) ABSTRACT

The present invention relates to a process for the manufacture of composite materials having lignocellulosic fibres dispersed in a thermoplastic matrix, while generally maintaining an average fibre length not below 0.2 mm. The process comprises defibrillation of the lignocellulosic fibres using a mixer and at a temperature less than the decomposition temperature of the fibres in order to separate the fibres and generate microfibres, crofÊbres, followed by dispersion of the fibres in the thermoplastic matrix by mechanical mixing to get the moldable thermoplastic composition, followed by injection, compression, extrusion or compression injection molding of said composition. The process produces high performance composite materials having a tensile strength not less than about 55 MPa, a flexural strength not less than about 80 MPa, a stiffness not less than about 2 GPa, notched impact strength not less than about 20 J/m, and un-notched impact strength not less than about 100 J/m. The composite materials of the present invention are well-suited for use in automotive, aerospace, electronic, furniture, sports articles, upholstery and other structural applications.

### FIELD OF THE INVENTION

This invention relates generally to lignocellulosic fibre/thermoplastic composites. This invention relates more particularly to a method of producing a lignocellulosic fibre/thermoplastic composition with improved material characteristics.

### BACKGROUND OF THE INVENTION

Lignocellulosic fibre composites are widely used in a broad spectrum of structural as well as non-structural applications including automotive, electronic, aerospace, building and construction, furniture, sporting goods and the like. This is because of the advantages offered by natural fibres compared to conventional inorganic fillers, including:
plant fibres have relatively low densities compared to inorganic fillers;
plant fibres result in reduced wear on processing equipment;
plant fibres have health and environmental related advantages;
plant fibres are renewable resources and their availability is more or less unlimited;
composites reinforced by plant fibres are CO₂ neutral;
plant fibres composites are recyclable and are easy to dispose of; and complete biodegradable composite products can be made from plant fibres if used in combination with biopolymers.

There is extensive prior art in the field of lignocellulosic fibre composite materials. Notably, Zehner in U.S. Pat. No. 6,780,359 (2004) describes a method of manufacturing a component involving mixing cellulosic material with polymer, forming composite granules and molding granules into a component, utilizing a selection of thermoplastic resins, cellulose, additives, and inorganic fillers as feedstock and specifying a preference of wood flour over wood fibre in order to achieve a coating of cellulose by the plastic matrix.

Hutchison et al. in U.S. Pat. No. 6,632,863 (2003) teaches manufacturing of a pellet cellulosic fibre, blending the pellet with more polymer to form a final composition and molding said pellet into articles.

Snijder et al. in U.S. Pat. No. 6,565,348 (2003) describes a multi-zone process involving melting the polymer, feeding the fibre into the melt and working the mixture, and extruding the mixture and form granules.

Sears et al. in U.S. Pat. No. 6,270,883 (2001) describes use of a twin-screw extruder blending of fibre granules or pellets with the polymer and additives.

Medoff et al. in U.S. Pat. No. 6,258,876 (2001) teaches a process for manufacturing a composite comprising shearing lignocellulosic fibres to form texturized fibres, and combining them with a resin. Medoff et al. in U.S. Pat. No. 5,973,035 (1999) teaches a similar cellulosic composite.

Mechanical properties of the lignocellulosic fibre-filled polymer composites are generally determined by: (i) the length of the fibres in the composite; (ii) the dispersion of the fibres in the polymer matrix; (iii) the interfacial interaction between the fibres and the polymer matrix; and (iv) the chemical nature of the fibre. In conventional lignocellulosic fibre composites, fibre agglomeration has been observed, which may be a constraint in developing structural materials.

Challenges involved with the development of a manufacturing process for high performance structural materials from short lignocellulosic filled thermoplastic materials include retention of the fibre length required for the effective stress transfer from the matrix to the fibre, and well dispersion of fibres in the matrix to avoid stress concentrating agglomerates, in addition to a good fibre matrix interfacial adhesion which enhances the stress transfer to the fibre.

Lignocellulosic fibres are generally rich in hydroxyl groups, and because of the strong hydrogen bonds between these hydroxyl groups it is often difficult to get a homogeneous dispersion of these fibres in the generally hydrophobic thermoplastic matrix. The hydrophilic cellulosic fibres are generally incompatible with the hydrophobic thermoplastic matrix and this typically leads to poor wetting and dispersion of the fibres. Use of proper interface modifiers can improve the wetting and dispersion to a certain extent and improve the performance of the composites.

Some developments have been made with respect to improving dispersion and interfacial adhesion and hence to improving properties of lignocellulosic composites, for example:
In U.S. Pat. No. 4,250,064 (1981), Chandler describes the use of plant fibres in combination with inorganic filler such as CaCO₃ to improve the dispersion of fibres in the polymer matrix.
Methods such as pretreatment of cellulosic fibres by slurrying them in water and hydrolytic pre-treatment of cellulosic fibres with dilute HCl or H₂SO₄ was described by Coran et al. and Kubat et al. in U.S. Pat. Nos. 4,414,267 (1983) and 4,559,376 (1985), respectively.
Pretreatment of cellulosic fibres with lubricant to improve dispersion and bonding of the fibres in the polymer matrix was disclosed by Hamed in U.S. Pat. No. 3,943,079 (1976).
Use of functionalized polymers and grafting of cellulosic fibres with silane for improving dispersion and adhesion between fibre and matrix have been disclosed by Woodhams in U.S. Pat. No. 4,442,243 (1984) and Beshay in U.S. Pat. No. 4,717,742 (1988), respectively.
Raj et. al in U.S. Pat. No. 5,120,776 (1992) teaches a process for chemical treatment of discontinuous cellulosic fibres with maleic anhydride to improve bonding and dispersability of the fibres in the polymer matrix.
Beshay in U.S. Pat. No. 5,153,241 (1992) explained use of titanium coupling agent to improve bonding and dispersion of cellulosic fibres with the polymer.
Horn disclosed, in U.S. Pat. No. 5,288,772 (1994), the use of pre-treated high moisture cellulosic materials for making composites.
A hydrolytic treatment of the fibres at a temperature of 160-200 degrees Celsius using water as the softening agent has been claimed by Pott et al. in Canadian Patent No. 2,235,531 (1997).
Sears et al. disclosed a reinforced composite material with improved properties containing cellulosic pulp fibres dispersed in a high melting thermoplastic matrix, preferably nylon, as described in U.S. Pat. No. 6,270,883 (2001) and European Patent No. 1121244 (2001).

Performance of a discontinuous fibre filled composite is also dependent on fibre length, since longer discontinuous fibres generally have the capacity to withstand greater stress and hence have greater tensile properties than shorter fibres of similar nature, as larger fibres can absorb more stress prior to failure than a shorter fibre. Jacobsen disclosed in U.S. Pat. No. 6,610,232 (2003) the use of long discontinuous lignocellulosic fibres for thermoplastic composites.

Another technique to improve the dispersion of the lignocellulosic fibres is to use high shear during melt blending of the fibres with plastics. Since the fibres are prone to break down, the high shear results in small fibres in the resultant compound where the fibres are not effective to carry the load from the matrix. In other words, due to the high shear, the fibre length is reduced to less than the critical fibre length. This is especially significant where inorganic glass fibres are used in combination with organic fibres. Glass fibres easily breakdown to small length and this adversely prevents the exploitation of the full potential of the composite materials. In order to achieve a high performance material from lignocellulosic thermoplastic composites, it is therefore important to well disperse the fibres in the matrix while preserving the critical fibre length.

An earlier patent application of the present inventors, namely United States Publication No. 20050225009, and application Ser. No. 11/005,520, filed on Dec. 6, 2004 disclosed a process to obtain high performing cellulosic and glass fibre filled thermoplastic composites with improved dispersion of the cellulosic fibres.

Although prior art shows the processing of thermoplastic composites containing different lignocellulosic fillers with different combinations of thermoplastics, coupling agents, and fibre treatments, they are generally deficient in producing high strength performance cellulosic filled thermoplastic composite materials, which is attained by the present invention. The present invention can achieve high performance structural composite materials where the organic fibres have an effective fibre length and well dispersed and bonded with the thermoplastic matrix materials. Also, there is a need in certain applications for thermoplastic composites containing lignocellulosic fibre without glass fibre. There is a further need for producing such thermoplastic composites that have desirable thermal resistance characteristics.

### BRIEF SUMMARY OF THE INVENTION

In one aspect of the present invention, a method of producing high performance lignocellulosic fibre filled thermoplastic structural composites is provided. The production method involves defibrillation and dispersion of the lignocellulosic fibres into a thermoplastic matrix using a mixer.

In a more particular aspect of the present invention, a method is provided by which lignocellulosic fibre filled structural polymer composite materials can be produced after being injection, compression, extrusion or compression injection molded into structural composite products with the following material characteristics being generally and preferably achieved: tensile strength not less than about 55 MPa; flexural strength not less than about 80 MPa; stiffness not less than about 2 GPa; notched impact strength not less than about 20 J/m; and un-notched impact strength not less than about 100 J/m. The method comprises defibrillating the lignocellulosic fibres in a thermokinetic high shear mixer during a time period that is operable to achieve the separation of hydrogen-bonds between the fibres and the generation of microfibres, followed by the dispersion of the lignocellulosic fibres in a thermoplastic matrix by mechanical mixing, or “kneading”, at a temperature that is greater than the melt temperature of the thermoplastic and less than the decomposition temperature of the lignocellulosic fibres, during a time period that is operable to achieve the dispersion or blending of the lignocellulosic fibres throughout the thermoplastic. The resulting characteristics of the composite product, having mechanical entanglement of the lignocellulosic fibres and interfacial adhesion between the fibres and the thermoplastic, yield a material with high strength characteristics that is generally well-suited for structural applications, including in the automotive, aerospace, electronic, furniture and other industries.

Thermoplastic matrix materials suitable for use in accordance with the present invention include polyolefin and polypropylene, as examples, as well as other thermoplastic materials such as polyethylene, polystyrene, polyethylene-polypropylene copolymers, poly-vinyl chlorides, polylactides, polyhydroxyalkonates and polyethyleneterephthalate.

Interface modifiers, for example, surface active agents, may be used in the composite depending on the chemical properties of the thermoplastic, e.g., maleated polypropylene with propylene used as the matrix material. Other surface active agents for use in accordance with the present invention include maleated polyethylene, maleated polystyrene, maleated polylactides, maleated hydroxybutyrates and maleated terephthalates in combination with polyethylene, polystyrene, polylactides, polyhydroxyalkonates and polyethylene terephthalates, respectively.

The lignocellulosic fibres used in the present invention can be obtained from both wood sources, including softwood or hardwood, as well as non-wood fibres, often referred to as agro-pulp. The fibres can be prepared using common chemical, mechanical, or chemi-mechanical pulp processes, in a manner that is known.

As mentioned earlier, the composite product in accordance with the present invention is well-suited for many structural applications, preferably in the automotive, aerospace, electronic and/or furniture industry, and are capable of meeting various stringent requirements including cost, weight reduction, fuel efficiency, disposal, and recycling.

The present invention is advantageous with respect to the ability to maximize performance properties in comparison with known techniques. The composite product in accordance with the present invention can compete with existing glass fibre filled composite, and use of lignocellulosic fibres reduces the amount of plastics and synthetic fibres used in the composite resulting in energy savings due to a reduced quantity of polyolefin and glass fibre, which are generally much more energy intensive compared to that of natural fibre production.

### BRIEF DESCRIPTION OF THE DRAWINGS

A detailed description of the preferred embodiment(s) is(are) provided herein below by way of example only and with reference to the following drawings, in which:

FIG. 1 illustrates the microfibre development during the course of defibrillation in accordance with the present invention, at 70 times magnification.

FIG. 2 illustrates the microfibre development during the course of defibrillation in accordance with the present invention, at 80 times magnification.

FIG. 3 illustrates the initial stage of fibre opening during the course of defibrillation in accordance with the present invention, at 500 times magnification.

FIG. 4 illustrates the microfibre development during the course of defibrillation in accordance with the present invention, at also at 500 times magnification in another view thereof. Separate microfibres are visible at the bottom part of the micro-photograph with fibre diameter less than 10 microns.

FIG. 5 illustrates the reduction of fibre diameter during the course of defibrillation in accordance with the present invention, at 1000 times magnification.

FIG. 6 illustrates the microfibre development on the fibre surface during the course of defibrillation in accordance with the present invention, also at 1000 times magnification in another view thereof.

FIG. 7 illustrates the average fibre diameter before defibrillation in accordance with the present invention, at 5000 times magnification.

FIG. 8 illustrates the microfibre development with diameter less than 10 micron during the course of defibrillation in accordance with the present invention, also at 5000 times magnification in another view thereof.

FIG. 9 illustrates creep behavior of 40% by weight of TMP filled polypropylene composite under flexural load at ambient condition.

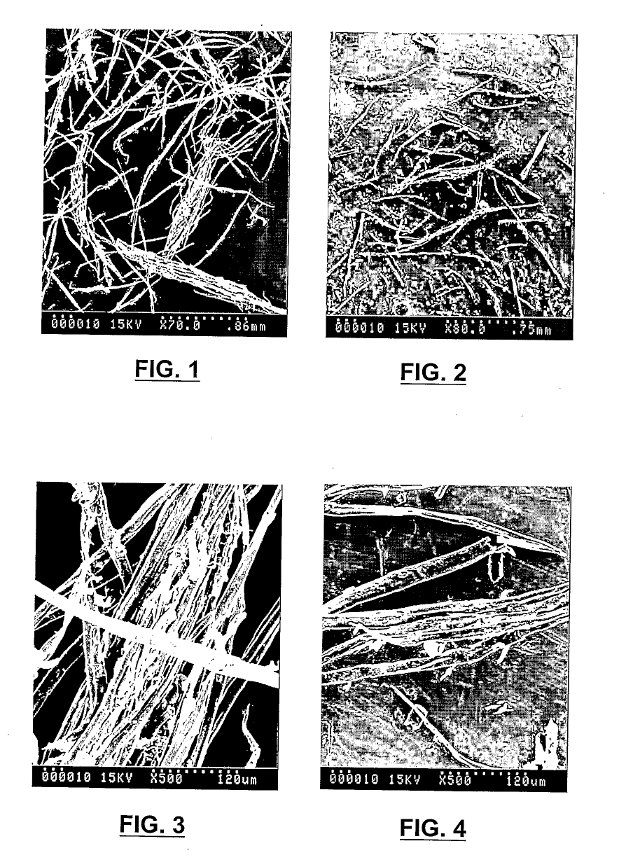

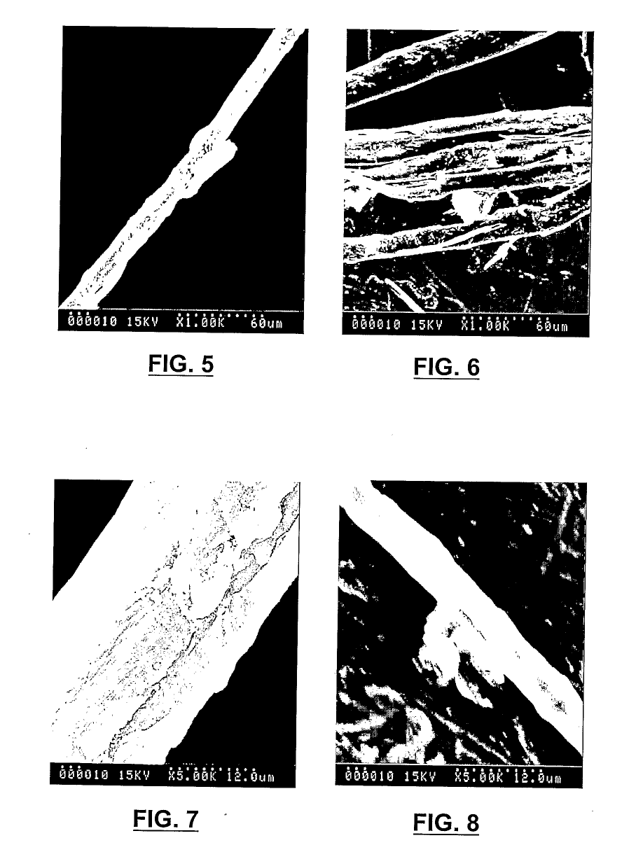

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The natural fibre composite products of the present invention have enhanced properties, preferably tensile strength not less than about 55 MPa, flexural strength not less than about 80 MPa, stiffness not less than about 2 GPa, notched impact strength not less than about 20 J/m, and un-notched impact strength not less than about 100 J/m.

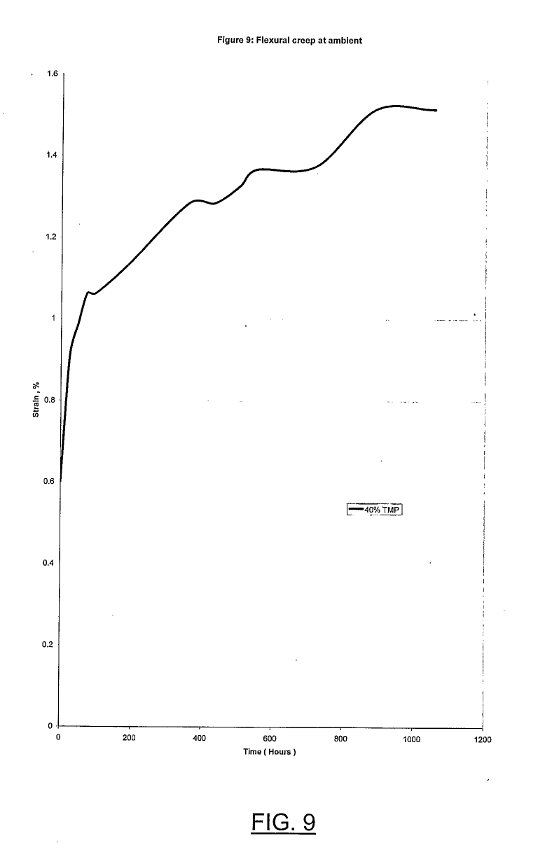

FIG. 9 illustrates the properties of the fibre/thermoplastic composite of the present invention. Samples of the composite were tested for creep resistance properties by allowing them to stand a load of 30% of their flexural load as a function of time. The deflection of the samples as a function of time was measured and is shown in FIG. 9, as defined by creep. The higher the creep, the lower the load bearing capacity. A very low creep value indicates that the composite has good load bearing qualities.

The present invention provides a method of producing high performing moldable and recyclable lignocellulosic fibre filled thermoplastic compositions and structural composite products consisting of lignocellulosic fibres dispersed in a matrix of thermoplastic material. Preferably, the fibre/thermoplastic composite comprise of less than or equal to 60% by weight cellulosic fibres, where lignocellulosic fibres have a moisture content of less than 10% by weight, and preferably less than 2% by weight. Depending on the chemical composition of the thermoplastic used in developing the composition, an interface modifier, e.g., surface active agent, may be included to improve the interaction between the cellulosic and inorganic fibres with the matrix and to assist with dispersing the cellulosic fibres throughout the matrix.

The defibrillation of the lignocellulosic fibres is achieved by mixing, preferably in a high shear thermo-kinetic mixer, for a period of time that is operable to provide effective defibrillation, i.e. separate the hydrogen-bonded fibres and generate microfibres. This period of time is generally not less than at least 10 seconds. The time required for the defibrillation to generate microfibres depends on the initial temperature of the mixer and the shear generated inside the mixer; the shear generated inside the mixer depends on a number of factors including the volume of the mixing chamber, the fibre volume, screw speed or tip velocity of the mixer screw and the configuration of the mixer screw. For example, the time required for the generation of microfibres, at a tip speed of 20-30 m/s, corresponding to 2500-3500 rpm for a screw/rotor diameter of 40 mm is anywhere between 20 seconds to 2 minutes depending on the initial temperature. It should be understood that the foregoing parameters are not essential, however, they illustrate the industrial operability of the present invention, where reducing production time is desirable. In a number of tests, it was found that around 30 seconds of rotation was a good average operable defibrillation time.

The defibrillation should be carried out at a temperature less than the decomposition temperature of the fibres, and in one particular embodiment of the present invention preferably at a temperature range of 100-140 degrees Celsius. It should be understood that this range of 100-140 degrees Celsius is not essential, and the present invention is not inoperable outside of this range, however, this range (depending on the various parameters described herein) in most application provides a temperature range that delivers good results (as particularized herein).

It should be understood that in some case the fibre may already be generally separated, or “open”, thereby requiring less rotation as described above or in fact no defibrillation. This is not typically the case, but depending on cost “open” fibre may be available. In this case, in accordance with another aspect of the present invention the defibrillation relates to achieving the fibre length parameters discussed below.

“Microfibres”, as the term is used in this disclosure, means fibrils which develop on the surface of the individual lignocellulosic fibre, and which either remain attached to the surface of the fibre or are partially or fully separated during high shear mixing, as illustrated in the Figures. The microfibres typically have a relatively small diameter relative to diameter of the fibres prior to defibrillation. The generation of microfibres increases the surface area of the fibres and causes mechanical entanglement and furthers the eventual interfacial adhesion between the fibres and the thermoplastic matrix and the fibres themselves, resulting in the production of an interpenetrating network structure and thereby causing an overall increase in the strength of the composite. Further, the strength of the fibre is enhanced by the formation of microfibres because the number of fibre defects decreases as the fibre diameter decreases.

In a particular aspect of the present invention, the defibrillation generates microfibres on the fibre surface due to a high shear generated during the process in the thermo-kinetic mixer. Undetached microfibres typically have a relatively small diameter and an average aspect ratio greater than 10 (length measured from the point of attachment of the fibril on the fibre surface to the loose end). This microfibre formation is dependent on the time and intensity of shear imparted on the fibre surface and also depends on the dynamic temperature profile inside the thermo-kinetic mixer. The defibrillation generally causes the microfibre diameter to decrease significantly to achieve the aspect ratio referred to above. The microfibre formation also results in the formation of anchors on the fibre surface, which then penetrate the molten plastic matrix to form a microfibre-enhanced plastics interface during the melt-blending step described below. Again, this improves the mechanical entanglement and provides for an interpenetrating fibre network structure within the matrix, and greatly increases the strength of the composite due to two specific effects: (i) the increased surface area of the microfibres improves overall surface area of interaction between the molten plastic and fibres; and (ii) the enhanced strength of the microfibres compared to that of the fibre helps to improve mechanical performance and other known performance attributes of the composite. The enhanced strength as per (ii) results from less heterogeneous fibre composition, their greater uniformity due to fewer impurities such as lesser amount of fibre damage, residual lignin, and/or hemicelluloses. The heterogeneous composition of fibre with larger diameter results from multiple microfibres being bonded together physically or chemically. These bundles of microfibres have multiple interfaces. The higher the number of microfibre interfaces, the greater the likelihood of defects or structural damage (e.g., due to friction or due to inherent nature of the fibre). The greater the incidence of defects, the weaker the fibres. Defibrillation, in accordance with the present invention, reduces the number of interfaces in fibre bundles by developing more homogeneous microfibres and therefore the number of resultant defects or damage.

Also, microfibre formation results in greater net surface area per unit of weight. This greater net surface area results in improved interfacial adhesion between the fibres and the matrix developed by good dispersion, as discussed below, produce a composite material with superior performance characteristics.

Compositions coming out from the thermo-kinetic mixer in the form of lumps may be used with or without a granulation for the subsequent processing steps. In other words, the lumps coming out from thermo-kinetic mixer could be used for subsequent processing steps without further granulation or pelletization.

Suitable lignocellulosic fibres can be pulp manufactured by mechanical refining, chemical pulping or a combination of both. Known chemical pulp manufacturing processes include high temperature caustic soda treatment, alkaline pulping (kraft cooking process), and sodium sulfite treatment. Suitable fibres include commercially available unbleached thermo-mechanical pulp (TMP), bleached thermo-mechanical pulp, unbleached chemi-thermo-mechanical pulp (CTMP), bleached chemi-thermo-mechanical fibre (BCTMP), kraft pulp and bleached kraft pulp (BKP). The fibres can be selected from any virgin or waste pulp or recycled fibres from hardwood, softwood or agro-pulp. Hardwood pulp is selected from hardwood species, typically aspen, maple, eucalyptus, birch, beech, oak, poplar or a suitable combination. Softwood pulp is selected from softwood species, typically spruce, fir, pine or a suitable combination. Agro-pulp includes any type of refined bast fibres such as hemp, flax, kenaf, corn, canola, wheat straw, and soy, jute or leaf fibres such as sisal. Alternatively, the fibre pulp selection can include a suitable combination of hardwood and softwood or a combination of wood pulp and agro-pulp.

The initial moisture content of the pulp fibre influences the processing and performance properties of composite. A moisture content of below 10% w/w is recommended. More specifically, the pulp moisture content that is below 2% w/w is preferred.

Depending on the nature of wood species, the performance of the composite of the present invention may vary significantly. For example, a hardwood species, such as birch in the brightness range of above 60 ISO % (according to the TAPPI (Technical Association of the Pulp and Paper Industry) standard) can provide improved mechanical performance compared to that of maple, for example. Similarly, agro-pulp, and other fibres that are easy to defibrillate tend to give higher mechanical performance. For example, chemical and mechanical pulps made from hemp and flax provide improved performance compared to that of corn or wheat stalk pulp based composites. These varying characteristics of pulp fibres and their selection for applications dependent on such characteristics are well known to those skilled in the art.

Specific fibre characteristics in accordance with the present invention include the following. The average lengths of the fibres are generally about 0.2 to 3.5 mm, with the average diameter of natural fibre ranging between about 0.005 mm to about 0.070 mm. It should be understood that this depends on the average diameter of the fibre before defibrillation. The fibres generally have a brightness value between 20 and 97 ISO (according to TAPPI Standard), and typically between 60 to 85 ISO. Another important characteristic of the fibres is the fibre compactness and bulk density. Fibres are fed in the form of loosely held agglomerates having density (including air) of about 20 grams per cubic centimeter or more and freeness not below 40 CSF (CSF means Canadian Standard Freeness and is described in the prior art). The fibres have a reciprocal bulk density between about 0.6 to 3.8 cubic centimeters per gram, and typically between 0.7 to 3.0 cubic centimeters per gram. The average fibre length as relates to “pulp freeness” needs to be controlled. The freeness of fibres are in the range of about 50 to 600 CSF (TAPPI standard), and typically between 100 to 450 CSF. In addition, fibres are typically not 100% lignin free and they may typically contain 0.01% to 30% (w/w) lignin.

Although brightness of the pulp can be varied depending on the performance requirement, a brightness range above 40 ISO (TAPPI Standard) is preferred. A pulp bleached or brightened with oxidizing and/or reducing chemicals could influence the overall mechanical performance, dispersion of the fibres and the microfibre formation. In general, the higher the brightness, the higher the microfibre formation in thermo-kinetic mixer. A brightness range above 60 ISO is particularly suitable for efficient generation of microfibres.

The matrix material used in the present invention comprises a polymeric thermoplastic material with a melting point less than a decomposition temperature defined for the lignocellulosic fibre (whether such lignocellulosic is treated or such melting point characteristics are inherent) as is known to those skilled in the art. Based on operation of the present invention using the materials described in the present disclosure, in one particular embodiment of the present invention, the polymeric thermoplastic material has a melting point preferably less than 230 degrees Celsius. In another particular embodiment of the present invention, the polymeric thermoplastic material has a melting point of less than 250 degrees Celsius. It should be understood that the melting point varies according to the thermoplastic material, and so does the decomposition temperature, based on well known parameters.

Suitable polymeric materials include polyolefins, preferably polypropylene (e.g., general purpose injection mold or extrusion grade with a density of 0.90 g/cm³), polyethylene, copolymers of propylene with other monomers including ethylene, alkyl or aryl anhydride, acrylate and ethylene homo or copolymer, or a combination of these. Still further materials include polystyrene, polyvinyl chloride, nylon, polylactides, and polyethyleneterephthalate.

The surface active agents that may be used in accordance with the present invention depend on the chemical composition of the thermoplastic, as will be readily understood by a person of skill in the art. Suitable surface active agents include functional polymers, preferably maleic anhydride grafted polyolefins, terpolymers of propylene, ethylene, alkyl or aryl anhydrides and alkyl or aryl acrylates, maleated polypropylene, acrylated-maleated polypropylene or maleated polyethylene, their acrylate terpolymers, or any suitable combination for use with polypropylene and polyethylene matrix materials. Other useful coupling agents include maleated polystyrene and maleated polylactide in combination with polystyrene and polylactide matrix materials. Preferably, the surface active agent(s) is/are present in an amount greater than 2% by weight and less than 15% by weight of the entire composition of the composite, and more preferably in an amount less than or equal to 10% by weight.

After defibrillation, the fibres are melt blended, or “kneaded”, with the matrix by mechanical mixing achieved, for example, in the same high shear thermo-kinetic mixer in situ. The melt blending time depends on the temperature of the mixer, shear generates inside the mixer, as the blending or kneading stops at the upper set temperature. For example, the initial temperature of the mixer is lower, then the time required to reach the set temperature will be more compared to a higher initial mixing temperature.

The total residence time in the high shear mixer, i.e. the total time for defibrillation and kneading, varies for example from 1 minute to 4 minutes, depending on the conditions used. It should be understood that this is important as the defibrillation of the fibres and their dispersion in the polymer matrix depends on the residence time. As stated, the improved performance in the present invention is a combined effect of physical and physical/chemical entanglement developed by the microfibres structure and the interfacial adhesion formed between said structure and the thermoplastic matrix, in the presence of one or more functional additives such as surface active agents as described above.

The degree of agglomeration is a good measure as to the dispersion of fibres, as well as detached microfibres, within the thermoplastic matrix. In essence, a perfect dispersion means that there are no visible agglomerates of fibres in a thin film formed from the composites. Typically, visible agglomerates in such a composite are in the range of about 250 micrometers and above. The degree of agglomeration, as determined by an image analyzer, is the number and the sizes of agglomerates that are present in the final composition per unit surface area of the composite film. A good dispersion within a composite as taught by the present invention yields composite material that contains less than one visible agglomerate of size 250 micrometers and above per square inch of a thin film.

An important factor in the defibrillation and dispersion stages is the residence time. The higher the residence time under high shear, the greater the microfibre formation. Also, higher residence time during the dispersion stage means better dispersion. The present invention involves maximizing residence time during the defibrillation and dispersion stages while ensuring that the temperature over time does not attain the decomposition temperature. While the decomposition temperature provides the upper limit of temperature within the mixer, in accordance with the present invention, about 230 degrees Celsius is defined as an appropriate upper limit as many fibres begin discoloration at this temperature, which generally means that the decomposition temperature is not far behind.

Therefore, 230 degrees Celsius, in a particular embodiment of the present invention, is defined as the upper temperature limit for defibrillation, depending on the selected fibres. It should be understood that the references to an upper limit of temperature within the mixer refers to the bulk temperature for the material rather than the sensor temperature. It is possible to set the upper temperature limit of the actual mixer sensor even higher (up to around 320 degree Celsius) without decomposing the material, since the set temperature limit is the sensor temperature which determines localized temperature in the melt but not the defibrillation temperature and, the bulk temperature of fibre may not exceed 230 degree Celsius unless an unusually high residence time, typically over 4 minutes, is used to the end of melt-mixing. Typically, the molten composition stays at the set sensor temperature only for a few seconds as the temperature raises relatively suddenly once melt-mixing starts. This process is called fluxing and is well-known in the art. The set temperature also depends on the tip speed of the mixer and the initial temperature of the mixer.

As well, the sequence of the addition of fibres, thermoplastic and additives into the thermo-kinetic mixer is also significant. Typically, the fibres are added and defibrillated for a minimum residence time to provide adequate microfibre generation and dispersion of fibres. During this time, the temperature in the mixing zone rises. Once an adequate residence time has been achieved, the polymers and additives (if applicable) are added. These parameters are well known to those skilled in the art.

When the defibrillation and dispersion of the individual fibres is formed by a high shear mixing process as described above, the dispersion of these fibres and microfibres can be further improved by adding an extra step where the composites mixtures are further dispersed in a low shear thermo-mechanical process, such as a extruder, injection or a compression injection process, whereby the extruders are designed to reduce fibre breakage. Compression and then dispersion of the melt-mix under high pressure injection in a compression-injection process is described in the prior art as a process where the composites formed in the first stage are heat melted and then injected in a cavity under very high pressure.

According to one particular embodiment, discontinuous lignocellulosic pulp fibres were defibrillated for not more than 4 minutes in a high shear mixer and melt blended to disperse the fibres with thermoplastic material in the presence of surface active agents (if applicable) in a high shear thermokinetic mixer.

Another embodiment relates to a method of making injection or compression or compression injection molded composite products from the granulates or pellets of the fibre/thermoplastic composite of the present invention or using them as is without forming any granulates or pellets as they comes out in the forms of lumps from the high speed mixer. Preferably the method comprising injection molding of the pre-dried granulates or pellets by removing moisture by drying to below 5% by weight. In a process of injection compression molding, a minimum pressure of 200 tones is recommended. In accordance with the present invention, dispersion of the fibre in the polymer matrix can be further improved by increasing the injection pressure up to 1200 tones without increasing the melt temperature above 230 degrees Celsius in most applications, based on the parameters described herein.

According to one embodiment of the present invention, the composite comprising thermoplastic filled with bleached pulp has tensile and flexural strengths greater than that of the unfilled thermoplastic matrix material and tensile and flexural moduli greater than that of unfilled thermoplastic matrix material. More preferably, the composite has tensile and flexural strength and moduli greater than that of the thermoplastic matrix material.

According to another embodiment, the composite comprising thermoplastic filled with thermo-mechanical pulp (TMP) has tensile and flexural strengths greater than that of the unfilled thermoplastic matrix material and tensile and flexural moduli greater than that of unfilled thermoplastic matrix material. More preferably, the composite has tensile and flexural strength and moduli greater than that of the thermoplastic matrix material.

According to another embodiment, the composite comprising thermoplastic filled with unbleached kraft fibres has tensile and flexural strength greater than that of the unfilled thermoplastic matrix material and tensile and flexural moduli greater than that of unfilled thermoplastic matrix material. More preferably, the composite has tensile and flexural strength and moduli greater than that of the thermoplastic matrix material.

According to another embodiment, the composite comprising thermoplastic filled with chemi-thermo-mechanical wood fibres has tensile and flexural strength greater than different from the unfilled thermoplastic matrix material and tensile and flexural moduli greater than that of unfilled thermoplastic matrix material. More preferably, the composite has tensile and flexural strength and moduli greater than that of the thermoplastic matrix material.

According to another embodiment, the defibrillation of the lignocellulosic fibres and their dispersion in the molten thermoplastic occurs in a single stage of a high shear mixing process, with the generation of microfibres occurring prior to the dispersion in the thermoplastic matrix.

In yet another embodiment, the amount of natural fibre that could be introduced is up to 60% by total weight of the composition. A preferred range of natural fibre content in the composition is between 30 percent by weight of the total composition to about 50 percent by weight of the total composition.

### EXAMPLES

The following examples illustrate some of the moldable thermoplastic compositions and composite products comprising lignocellulosic fibres and the methods of making the same within the scope of the present invention. These are illustrative examples only and changes and modifications can be made with respect to the invention by one of ordinary skill in the art without departing from the scope of the invention.

### Performance Properties of Polypropylene

For the purposes of comparison, the performance properties of polypropylene are shown in Table 1.

TABLE 1
Properties of polyolefin.

| ASTM Test | Performance property | |
|---|---|---|
| ASTM D638 | Tensile strength, MPa | 31.6 |
| ASTM D638 | Tensile Modulus, GPa | 1.21 |
| ASTM D790 | Flexural Strength, MPa | 50 |
| ASTM D790 | Flexural Modulus, GPa | 1.41 |

### Composition of Thermoplastic

Examples of the composition of the moldable thermoplastic composition are given in Table 2. Pulp fibres were defibrillated in a high shear internal mixer for not less than thirty seconds and melt blended with thermoplastic and surface active agents in the same mixer at a temperature not more than 190 degree Celsius. The melt composition from the internal mixer was granulated to prepare the lignocellulosic composite granulates.

TABLE 2
Composition of lignocellulosic composites.

| Materials (wt %) | Sample A | Sample B |
|---|---|---|
| Polypropylene | 55 | 45 |
| Chemi-thermomechanical pulp | 40 | 50 |
| Surface active agent | 5 | 5 |

Performance properties of the lignocellulosic composites (samples A and B) are summarized in Table 3. The composite samples exhibit a tensile strength of 62 and 72 MPa and a flexural strength of 95 and 116 MPa. Flexural stiffness of the said composites are 3.8 and 5 GPa, respectively. These composite products would be sufficient for applications requiring high strength and stiffness.

TABLE 3
Properties of lignocellulosic composites.

Sample

| ASTM Test | Performance property | A | B |
|---|---|---|---|
| ASTM D638 | Tensile strength, MPa | 63 | 72 |
| ASTM D638 | Tensile Modulus, GPa | 3.4 | 4.2 |
| ASTM D790 | Flexural Strength, MPa | 95 | 116 |
| ASTM D790 | Flexural Modulus, GPa | 3.8 | 5.1 |
| ASTM D 256 | Notched impact strength, | 30 | 35 |
| | J/m | | |
| ASTM D 256 | Un-notched impact | 266 | 244 |
| | strength, J/m | | |

Tables 4 below illustrates the performance of composites in accordance with the present invention with two different additives, namely additive A containing an interface modifier with acrylate-maleate polypropylene, and additive B containing an interface modifier with maleated polypropylene.

TABLE 4
Properties of TMP composites with two different additive systems.

| | | Sample | | | |
|---|---|---|---|---|---|
| | | 30% TMP + | 35% TMP + | 40% TMP + | 50% TMP + |
| | | 5% | 5% | 5% | 10% |
| | | Additive | Additive | Additive | Additive |
| | Performance | A + 65% | B + 60% | A + 55% | B + 40% |
| ASTM Test | property | PP | PP | PP | PP |
| ASTM D638 | Tensile strength, | 47.5 | 50.2 | 52.5 | 61.4 |
| | MPa | | | | |
| ASTM D638 | Tensile Modulus, | 2.7 | 2.9 | 3.2 | 3.9 |
| | GPa | | | | |
| ASTM D790 | Flexural Strength, | 74.8 | 82 | 86 | 105 |
| | MPa | | | | |
| ASTM D790 | Flexural | 2.7 | 3.2 | 3.6 | 4.8 |
| | Modulus, GPa | | | | |
| ASTM D 256 | Notched impact | 22 | 20 | 23 | 28 |
| | strength, J/m | | | | |
| ASTM D 256 | Un-notched | 201 | 177 | 185 | 203 |
| | impact strength, | | | | |
| | J/m | | | | |

Tables 5 below further illustrates the performance of composites with additives, namely additive B containing an interface modifier with maleated polypropylene.

TABLE 5
Composite properties.

| | | Sample | |
|---|---|---|---|
| | | 40% TMP + | 50% TMP + |
| | | 5% | 5% |
| | | Additive B + | Additive B + |
| ASTM Test | Performance property | 55% PP | 45% PP |
| ASTM D638 | Tensile strength, MPa | 53.1 | 55.8 |
| ASTM D638 | Tensile Modulus, GPa | 3.2 | 3.4 |
| ASTM D790 | Flexural Strength, MPa | 87.7 | 91.1 |
| ASTM D790 | Flexural Modulus, GPa | 3.6 | 4.5 |
| ASTM D 256 | Notched impact strength, | 21 | 23 |
| | J/m | | |
| ASTM D 256 | Un-notched impact | 164 | 139 |
| | strength, J/m | | |

The extent of defibrillation of fibres required before their dispersion in the plastic phase further depends on the fibre characteristics such as the species used for manufacturing wood fibres, type of straws for agro fibres, method of manufacturing fibres such as chemical, mechanical, chemi-mechanical, thermo-mechanical and chemi-thermomechanical as stated in the prior art, the extent to which fibres are bleached or brightened, the temperature and the chemicals used during fibre development and brightening, etc. For example, mechanical properties of the composites prepared in the present invention under the same defibrillation time is different for the composites with different fibres, which indicates that the extent of defibrillation required for different types of fibres is different, which in turn depends on the fibre characteristics such as method of preparation of the fibres, for example, mechanical pulp or chemically treated pulp, or bleached pulp, etc. The fibres prepared by chemical pulping generally contain less lignin and are generally easy to defibrillate and give high mechanical performance compared to the fibres prepared by mechanical means.

### The Effect of Fibre Type on Properties

Table 6 shows a further example of the performance properties of the composites prepared as per the present invention using a constant defibrillation time. Note that the BCTMP fibre has a pulp brightness above 80% ISO.

TABLE 6
Composite properties.

| | | Sample | |
|---|---|---|---|
| | | 40% TMP + | 40% |
| | | 5% | BCTMP + |
| | | Additive B + | 5% Additive |
| ASTM Test | Performance property | 55% PP | B + 55% PP |
| ASTM D638 | Tensile strength, MPa | 53.1 | 63 |
| ASTM D638 | Tensile Modulus, GPa | 3.2 | 3.4 |
| ASTM D790 | Flexural Strength, MPa | 87.7 | 95 |
| ASTM D790 | Flexural Modulus, GPa | 3.6 | 3.8 |
| ASTM D 256 | Notched impact strength, | 21 | 30 |
| | J/m | | |
| ASTM D 256 | Un-notched impact | 164 | 266 |
| | strength, J/m | | |

As discussed herein, the pulp fibres which are of interest include all types of commercial pulp fibre such as mechanical pulp, chemi-thermomechanical pulp, kraft pulp, sulphite pulp, bleached pulp fibres derived from agro-fibres, softwood, or hardwood species.

### Effect of Defibrillation Time on Fibre Properties

The following examples show the effect of defibrillation time on the properties of different types of pulp fibres, for example, thermo-mechanical pulp (TMP) and chemi-thermomechanical pulp also known as high yield pulp in the prior art (BCTMP). The pulp fibres are relatively easy to defibrillate, i.e. for example, chemi-thermomechanical pulp requires less extent defibrillation in the thermokinetic mixing process to achieve the desired properties, and increase in the defibrillation time actually leads to lower mechanical properties of the composite end product. The pulp fibres which are not easy to defibrillate, for example, thermomechanical pulp, requires more defibrillation in the thermokinetic mixing process and an increase in the defibrillation time leads to further enhancement of mechanical properties of composite end products. Table 7 below demonstrates the properties of the different pulp fibre composites (TMP and BCTMP) prepared in accordance with the present invention with different defibrillation times (listed in brackets) in a high speed thermokinetic mixing process. Selecting the right kind of pulp fibre that requires minimum time for defibrillation in the thermokinetic mixer is of particular interest from a commercialization standpoint.

TABLE 7
Effect of defibrillation time on composite properties.

| | | Sample | | | |
|---|---|---|---|---|---|
| | | | 40% | 40% | 40% |
| | | 40% BCTMP + | BCTMP + | TMP + | TMP + |
| | | 5% | 5% | 5% | 5% |
| | | Additive | Additive | Additive | Additive |
| | | B + 55% | B + 55% | B + 55% | B + 55% |
| | Performance | PP | PP | PP | PP |
| ASTM Test | property | (<20 sec) | (<45 sec) | (<5 sec) | (<45 sec) |
| ASTM D638 | Tensile strength, | 65.8 | 63 | 47.6 | 53.1 |
| | MPa | | | | |
| ASTM D638 | Tensile Modulus, | 3.5 | 3.4 | 2.95 | 3.2 |
| | GPa | | | | |
| ASTM D790 | Flexural Strength, | 101.8 | 95 | 83.3 | 87.7 |
| | MPa | | | | |
| ASTM D790 | Flexural | 4.07 | 3.8 | 3.58 | 3.6 |
| | Modulus, GPa | | | | |
| ASTM D 256 | Notched impact | 29 | 30 | 25 | 21 |
| | strength, J/m | | | | |
| ASTM D 256 | Un-notched | 242 | 266 | 123 | 164 |
| | impact strength, | | | | |
| | J/m | | | | |

In the above example, the decrease in mechanical properties for BCTMP seen with an increase in defibrillation time to more than 20 seconds is likely as a result of a reduction in fibre length which in turn results in lower strength. On the other hand, for TMP, increasing the resident time above 20 seconds increases the generation of microfibres and hence an improved dispersion in plastics and it resulted in better mechanical properties. Therefore, it should be understood that the end product performance of composite is a compromise between final fibre length and the extent of defibrillation.

### Properties of Composites Using Different Mixers

Defibrillation and dispersion of the fibres in the thermoplastic matrix also depends on the shear generated inside the mixer. The shear developed depends on the type of mixer, for example, a kinetic mixer or twin-screw extruder, tip speed or screw speed of the mixer, volume of the mixing chamber, amount of material inside the mixer etc. For example, a laboratory scale thermokinetic internal mixer of 1 L volume with a screw tip to tip diameter of 132 mm and a tip speed of 22 m/s needs a relatively high rpm of the rotor or screw to produce enough shear for the defibrillation and dispersion of the fibres in the thermoplastic matrix. A mixer of 25 L volume with the same tip speed requires less rpm to generate equivalent shear to that of the laboratory scale mixer for the defibrillation and dispersion of the fibres in thermoplastic matrix. Table 8 shows the properties of the composites prepared using a laboratory scale mixer and a pilot scale mixer with the approximately the same tip speed but with different screw rpm.

TABLE 8
Properties of composites prepared using different mixers.

| | | Sample | |
|---|---|---|---|
| | | 40% | 40% |
| | | BCTMP + | BCTMP + |
| | | 5% Additive | 5% Additive |
| | | B + 55% PP | B + 55% PP |
| ASTM Test | Performance property | (1 L mixer) | (25 L mixer) |
| ASTM D638 | Tensile strength, MPa | 63 | 63.2 |
| ASTM D638 | Tensile Modulus, GPa | 3.4 | 3.5 |
| ASTM D790 | Flexural Strength, MPa | 95 | 98.6 |
| ASTM D790 | Flexural Modulus, GPa | 3.8 | 4.1 |
| ASTM D 256 | Notched impact | 30 | 32 |
| | strength, J/m | | |
| ASTM D 256 | Un-notched impact | 266 | 214 |
| | strength, J/m | | |

Properties of Composites Prepared with a Short Defibrillation Time in a Kinetic Mixer

The following example shows the commercial interest of the present patent invention. Defibrillation of the fibres achieved by less than 5 seconds in a thermokinetic mixer and their dispersion in thermoplastic is achieved by not more than 60 seconds. The reduced time for defibrillation and dispersion in the mixer significantly reduce the energy consumption and the processing cost, which is of interest to the commercial producers. With the proper selection of the fibre and the processing conditions it is possible to achieve the defibrillation and dispersion within a shorter time and provide better mechanical performance. As an example, performance properties of the composites with bleached chemi-thermo-mechanical pulp (BCTMP) from birch species is given in the Table 9, whereby defibrillation of the fibres achieved in less than 5 seconds.

TABLE 9
Properties of composites prepared with a short defibrillation time.

| | | Sample |
|---|---|---|
| | | 40% BCTMP + 5% |
| | | Additive B + 55% PP |
| ASTM Test | Performance property | (defibrillation less than 5 sec) |
| ASTM D638 | Tensile strength, MPa | 67.5 |
| ASTM D638 | Tensile Modulus, GPa | 3.5 |
| ASTM D790 | Flexural Strength, MPa | 103.7 |
| ASTM D790 | Flexural Modulus, GPa | 4.1 |
| ASTM D 256 | Notched impact | 31 |
| | strength, J/m | |
| ASTM D 256 | Un-notched impact | 260 |
| | strength, J/m | |

Effect of Fibre Loading on the Properties of Composites

The process of present invention can use for the development of composites with different properties depending upon the final property requirements for specific applications by varying the fibre content. Table 10 summarizes the properties of composites prepared by the present process with different fibre contents and with the same processing additives and processing conditions.

TABLE 10
Effect of fibre loading on the properties of composites.

| | | Sample | | | |
|---|---|---|---|---|---|
| | Performance | 20% | 30% | 40% | 50% |
| ASTM Test | property | BCTMP | BCTMP | BCTMP | BCTMP |
| ASTM D638 | Tensile strength, | 44.4 | 55.6 | 63 | 72 |
| | MPa | | | | |
| ASTM D638 | Tensile Modulus, | 2.22 | 2.79 | 3.4 | 4.2 |
| | GPa | | | | |
| ASTM D790 | Flexural Strength, | 66.0 | 82.3 | 95 | 116 |
| | MPa | | | | |
| ASTM D790 | Flexural | 2.03 | 2.85 | 3.8 | 5.1 |
| | Modulus, GPa | | | | |
| ASTM D 256 | Notched impact | 25 | 29 | 30 | 35 |
| | strength, J/m | | | | |
| ASTM D 256 | Un-notched | 258 | 267 | 266 | 244 |
| | impact strength, | | | | |
| | J/m | | | | |

The effect of shear rate generated inside the mixing chamber affects the defibrillation time and dispersion of the fibres in the thermoplastic matrix which finally affects the properties of the final product. Table 11 illustrates the properties of the composites prepared by the present invention by varying the tip speed of the screw/rotor from 16.7 m/s to 32 m/s (tip speed is listed in brackets, with higher tip speed meaning higher shear). The speed of screw or rotor is related to the shear generated in defibrillation and dispersion. Increase in the tip speed in the given range/shear affects the impact strength, but no significant effect on the tensile and flexural properties. The defibrillation and dispersion time can be reduced by increasing the tip speed, which is of considerable interest to the commercial users of the present invention. By increasing shear or the tip speed from 16.7 to 22.8, residence time appears to be reduced by more than 50%.

TABLE 11
Effect of tip speed on the properties of composites.

| | | Sample | | |
|---|---|---|---|---|
| | | 50% | 50% | 50% |
| | Performance | BCTMP | BCTMP | BCTMP |
| ASTM Test | property | (16.7) | (22.8) | (32.0) |
| ASTM D638 | Tensile strength, | 72.5 | 72 | 74.4 |
| | MPa | | | |
| ASTM D638 | Tensile Modulus, | 4.30 | 4.2 | 4.39 |
| | GPa | | | |
| ASTM D790 | Flexural Strength, | 115.8 | 116 | 117.4 |
| | MPa | | | |
| ASTM D790 | Flexural | 5.16 | 5.1 | 5.21 |
| | Modulus, GPa | | | |
| ASTM D 256 | Notched impact | 33 | 35 | 32 |
| | strength, J/m | | | |
| ASTM D 256 | Un-notched | 239 | 244 | 189 |
| | impact strength, | | | |
| | J/m | | | |

The bulk density of the fibre before it is fed to the kinetic mixer affects the smooth and consistent feeding of fibres to the mixing chamber; generally the higher the bulk density easier to feed. However, a higher bulk density also decreases the extent of defibrillation and may result in poor dispersion of fibre in plastic matrix and it may result in poor composite performance.

Bulk density of the fibre feed can be controlled by carefully controlling the bale density of the fibre-bale and the cut size and shape before the fibre is fed to the mixer. (A bale is a compressed form of large quantity of fibre used for ease for transportation and further usage.) For example, a commercial (market) BCTMP birch pulp bale typically has a bale density of 0.7 g/cc and is easy to feed to the mixer but is difficult to achieve the required defibrillation and dispersion in a commercially viable production time period. On the other hand, a less compressed bale of 0.5 g/cc of bale density BCTMP from birch species provides good feeding as well as improved defibrillation and dispersion in the kinetic mixer in a relatively short and commercially viable time period.

1. A method of producing a lignocellulosic fibre/thermoplastic composite characterized in that the method includes the steps of:
(a) defibrillating lignocellulosic fibres in a mixer at a temperature less than the decomposition temperature of the lignocellulosic fibres, during a time period that is operable to achieve:
(i) separation of hydrogen-bonds present between the lignocellulosic fibres; and
(ii) generation of microfibres on the surface of the lignocellulosic fibres;
(b) dispersing the lignocellulosic fibres throughout a melted thermoplastic;
whereby the lignocellulosic fibres and microfibres dispersed in the thermoplastic achieve interfacial adhesion with the thermoplastic.

2. The method of claim 1 wherein the mixer is a thermokinetic high shear mixer.

3. The method of claim 1 wherein the defibrillating is achieved at a temperature of 100 to 140 degrees Celsius.

4. The method of claim 1 wherein the dispersing is achieved by mechanical mixing at a temperature greater than the melt temperature of the thermoplastic.

5. The method of claim 1 wherein the microfibres are either attached to the surface of the lignocellulosic fibres or detached.

6. The method of claim 5 wherein the detached microfibres further contribute to the interfacial adhesion with the thermoplastic.

7. The method of claim 1 wherein the lignocellulosic fibres are selected from pulp and is not more than 75 weight percent of the composite.

8. The method of claim 7 wherein the pulp is selected from hardwood pulp, softwood pulp or agro-fibre pulp.

9. The method of claim 7 wherein the wood pulp is manufactured by mechanical refining or chemical pulping, or a combination thereof.

10. The method of claim 7 wherein the lignocellulosic fibres have a moisture content of less than 10 weight percent.

11. The method of claim 1 wherein the lignocellulosic fibres have an average length of about 0.2 mm to 3.5 mm.

12. The method of claim 1 wherein the lignocellulosic fibres have an average diameter of about 0.005 mm to 0.070 mm.

13. The method of claim 1 wherein the lignocellulosic fibres have a bulk density of about 0.7 to 3.0 cubic centimeters per gram.

14. The method of claim 1 further comprising the step of applying at least one interface modifier to the lignocellulosic fibres so as to improve dispersion of the lignocellulosic fibres in the thermoplastic.

15. The method of claim 14 wherein the interface modifier is surface active agent and comprises between about 2 and 15 weight percent of the composite.

16. The method of claim 14 wherein the interface modifier is a functional polymer selected from the group consisting of maleated polyethylene, maleated polypropylene, copolymers and terpolymers of polypropylene containing acrylate and maleate, maleic anhydride grafted polystyrene, polylactide, polyhydroxyalkonate, or polyphenylene terephthalate, or any combination thereof.

17. The method of claim 1 wherein the dispersing occurs for no less than 10 seconds.

18. The method of claim 1 wherein the thermoplastic is selected from the group consisting of polyethylene, polypropylene, polystyrene, polyethylene co-polymer, polypropylene co-polymer, polyvinyl chloride, polylactic acid, polyphenylene terephthalate, or polyhydroxyalkonate, or any combination thereof.

19. The method of claim 1 further comprising granulating the lignocellulosic fibre/thermoplastic composite.

20. The method of claim 1 wherein the thermoplastic has a melting point of less than 250 degrees Celsius.

21. A method of producing a molded fibre/thermoplastic composite product, characterized in that the method comprises the steps of:
(a) defibrillating a mass of lignocellulosic fibres in a mixer to achieve separation of hydrogen-bonds and to generate microfibres;
(b) dispersing the lignocellulosic fibres throughout a thermoplastic by melt blending to produce a moldable fibre/thermoplastic composite; and
(c) injection, compression, extrusion or compression-injection molding the moldable fibre/thermoplastic composite to form a molded fibre/thermoplastic composite product.

22. A fibre/thermoplastic composite comprising:
(a) lignocellulosic fibres having a length of at least 0.2 mm and selected from wood pulp comprising hardwood pulp, softwood pulp or agro-pulp, and manufactured by mechanical refining or chemical pulping, or a combination thereof; and
(b) a thermoplastic;
characterized in that the lignocellulosic fibres have been defibrillated in a mixer to separate the hydrogen bonds and to generate microfibres; and
wherein the lignocellulosic fibres are dispersed in the thermoplastic and achieve interfacial adhesion with the thermoplastic.

23. An article of manufacture comprising the fibre/thermoplastic composite claimed in claim 22.

24. An article of manufacture of claim 23, whereby the fibre/thermoplastic composite is used for automotive, aerospace, electronic, furniture and other structural applications.
